(19) United States
(12) Patent Application Publication
(10) Pub. No.: US 2026/0133519 A1
(43) Pub. Date: May 14, 2026

(54) METHODS FOR IMPROVING INK LAYER ADHESION TO A SUBSTRATE SURFACE

(71) Applicant: SOLENIS TECHNOLOGIES, L.P., Wilmington, DE (US)

(72) Inventors: Murilo Toledo Suekuni, Wilmington, DE (US); Daniel F. Varnell, Wilmington, DE (US); Scott R. Lewis, Wilmington, DE (US)

(73) Assignee: SOLENIS TECHNOLOGIES, L.P., Wilmington, DE (US)

(21) Appl. No.: 19/382,556

(22) Filed: Nov. 7, 2025

Related U.S. Application Data
(60) Provisional application No. 63/717,916, filed on Nov. 8, 2024.

(51) Int. Cl. G03G 9/16; G03G 9/08; G03G 15/16

(52) U.S. Cl. CPC G03G 9/16; G03G 9/0823; G03G 15/1625

(57) ABSTRACT

Methods of enhancing adhesion of an ink layer to a surface of a substrate, and composite articles formed through the methods, are provided. The methods comprise applying a primer composition to the surface to form a primer layer disposed on the substrate. The primer composition comprises a first polymer comprising a repeating unit, wherein the repeating unit comprises a localized negatively charged dipole having a local dipole moment of greater than 2 debyes, and wherein the repeating unit comprises no localized positively charged dipole having a local dipole moment of greater than 0.8 debyes; and a second polymer comprising a repeating unit comprising a tertiary amine group, wherein the second polymer is a branched polymer having a branch with a primary amine group that is pendant from the backbone of the polymer. The weight ratio of the first polymer to the second polymer is from about 19:1 to about 1:9.

### CROSS-REFERENCE TO RELATED APPLICATIONS

This application claims the benefit of U.S. Provisional Application No. 63/717,916, filed Nov. 8, 2024, the entire contents of which are hereby incorporated by reference.

### TECHNICAL FIELD

The present disclosure generally relates to methods of enhancing adhesion of an ink layer to a surface of a substrate, and composite structures formed through the methods. The present disclosure more particularly relates to methods including a step of applying a primer composition to a surface of a substrate, and composite structures formed through the methods.

### BACKGROUND

Electrophotographic systems are used in digital printing to transfer digitally stored images and text onto a substrate to form customizable products such as packages, labels, and books. Common substrates include paper and polymeric materials. Electrophotographic systems include digital presses based on liquid electrophotographic (LEP) inks (Electroinks), such as those commercialized by Hewlett-Packard (HP) Indigo™ division.

Digital and other printing technologies have shortcomings. One of the major failures of electrophotographic printing systems is Electroink adhesion failure (i.e. separation of an Electroink layer from a substrate). Some substrates have an inability to form strong bonds with Electroinks, in part due to the topography and chemistry of the substrates. To address the problem of Electroink adhesion failure, primers have been developed that can be applied to the substrate prior to Electroink application in order to improve Electroink adhesion to the substrate. Primers work by introducing functional groups that will enhance ink-to-substrate interactions through, for example, hydrogen bonding and ionic forces.

Primers that have been developed for electrophotographic printing systems are largely based on ethylene-acrylic acid (EAA) copolymers or branched polyethyleneimine (PEI). EAA and PEI are known to aid Electroink adhesion on a variety of substrates, including paper substrates and pretreated polymeric substrates. In the case of EAA-based primers, the chemistry of the HP Electroink is based on polymers that are similar to EAA. However, primers containing EAA are inefficient, cause runnability issues, and require tedious cleaning procedures, resulting in excessive equipment downtime and reduced process efficiency. In the case of branched PEI-based primers, the primers undergo discoloration when applied to a substrate, leading to a printed product with non-optimal coloration.

Accordingly, it is desirable to provide a method of enhancing adhesion of an ink layer to a surface of a substrate by applying a primer composition that causes minimal discoloration, while still exhibiting excellent ink adhesion properties and minimized drying times of the applied primer when applied as a solution. Furthermore, other desirable features and characteristics of the present disclosure will become apparent from the subsequent detailed description and the appended claims, taken in conjunction with the accompanying drawings and this background.

### BRIEF SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Methods of enhancing adhesion of an ink layer to a surface of a substrate, and composite articles formed through the methods, are provided herein. In an embodiment, a method comprises the step of applying a primer composition to the surface to form a primer layer disposed on the substrate. The primer composition comprises a first polymer comprising a repeating unit, wherein the repeating unit comprises a localized negatively charged dipole having a local dipole moment of greater than 2 debyes, and wherein the repeating unit comprises no localized positively charged dipole having a local dipole moment of greater than 0.8 debyes. The primer composition further comprises a second polymer comprising a repeating unit comprising a tertiary amine group. The second polymer is a branched polymer having a branch with a primary amine group that is pendant from the backbone of the polymer.

### BRIEF DESCRIPTION OF THE DRAWINGS

The present disclosure will hereinafter be described in conjunction with the following drawing figures, wherein:

FIG. 1 shows the moisture content of primer compositions prepared and applied in accordance with Example 7 and Comparative Examples 7-8, as the resulting primer layers are dried over a time period of 1000 seconds.

FIG. 2 shows the moisture content of primer compositions prepared and applied in accordance with Example 7 and Comparative Example 9, as the resulting primer layers are dried over a time period of 1000 seconds.

FIG. 3 shows the moisture content of primer compositions prepared and applied in accordance with Example 7A and Comparative Examples 7A and 9A, as the resulting primer layers are dried over a time period of 1000 seconds.

### DETAILED DESCRIPTION

The following detailed description is merely exemplary in nature and is not intended to limit the present disclosure or the application and uses thereof. Furthermore, there is no intention to be bound by any theory presented in the preceding background or the following detailed description.

Methods of enhancing adhesion of an ink layer to a surface of a substrate are provided herein that exhibit minimal discoloration while achieving excellent ink adhesion properties and exhibiting minimized drying times. The methods comprise the step of applying a primer composition to the surface of the substrate to form a primer layer disposed on the substrate. The primer compositions comprise a first polymer comprising a repeating unit, wherein the repeating unit comprises a localized negatively charged dipole having a local dipole moment of greater than 2 debyes, and wherein the repeating unit comprises no localized positively charged dipole having a local dipole moment of greater than 0.8 debyes, and a second polymer comprising a repeating unit comprising a tertiary amine group, wherein the second polymer is a branched polymer having a branch with a primary amine group that is pendant from the backbone of the polymer.

Although applying to the surface of the substrate a primer composition containing the first polymer (e.g. polyethyloxazoline) alone results in insufficient ink adhesion properties, it has been found that applying a primer composition containing the first polymer in combination with the second polymer (e.g. branched polyethyleneimine) does not compromise the excellent ink adhesion properties known to result from applying a primer composition containing the second polymer alone. Further, it has been found that, due to unexpected intermolecular interactions between the first polymer and the second polymer, methods including applying a primer composition containing both the first polymer and the second polymer may exhibit minimized drying times. In addition, it has been found that applying a primer composition containing both the first polymer and the second polymer causes significantly less discoloration of the resulting primed substrate, as compared to applying a primer composition containing the second polymer alone.

Unless specifically stated or obvious from context, as used herein, the term “about” is understood as within a range of normal tolerance in the art measured using standard measurement devices for a given measurement, for example within 2 standard deviations of the mean for a particular measurement device. “About” can be understood as within 10%, 5%, 1%, 0.5%, 0.1%, 0.05%, or 0.01% of the stated value. “About” can alternatively be understood as implying the exact value stated. Unless otherwise clear from the context, all numerical values provided herein are modified by the term “about.”

As used herein, “solids content” refers to the percent, by weight, of non-volatile components that would remain after any solvents and/or volatile components are removed from a composition, based on a total weight of the composition.

As used herein, a “composition” refers to a formulation containing all the components as described herein, including appreciable amounts of solvent (e.g. at least 50 wt %) to facilitate application of the composition to a substrate surface, and before intended reaction of any of the recited components with moieties on a substrate surface. For example, a “primer composition” is a formulation containing the components described herein, including appreciable amounts of solvent, that can be applied to a substrate. As used herein, a “liquid toner” or “Electroink” refers to an “ink composition” containing all the components described herein, including appreciable amounts of solvent. A composition may be, for example, a solution or a dispersion.

As used herein, a “layer” refers to a dried substance present on a substrate. “Dried” refers to containing less than 10 wt % solvent, alternatively less than 1 wt % solvent, based on a total weight of the layer. For example, a “primer layer” refers to a layer formed by applying the primer composition to the substrate and drying until the solvent content is less than the above-recited values. An “ink layer” or “Electroink layer” refers to a layer formed by applying a liquid toner or Electroink to the substrate or primer layer and drying until the solvent content is less than the above-recited values.

As used herein, “ink adhesion” or “Electroink adhesion” refers to the bond between an ink layer and a surface of a substrate through a primer layer. A value of 100% adhesion means that there is no delamination between the ink layer and the surface of the substrate. A value of 0% adhesion means that the entire ink layer has delaminated (i.e. removed or separated) from the surface of the substrate.

As used herein, “substantially free” means less than 1 wt %, alternatively trace amounts that may be present but not intended, alternatively no detectable presence of the referenced component.

In accordance with embodiments of an exemplary method, a substrate is provided, a primer composition is applied to a surface of the substrate and dried to form a primer layer, and a liquid toner is applied to the primer layer and dried to form an ink layer.

In an embodiment, a substrate having a surface is provided. The substrate may be a single layer, or alternatively, the substrate may include multiple layers. The substrate as described herein includes all layers that are present before the primer layer is applied. The substrate may contain a material selected from paper, polymeric material, metal, fabric, wood, or combinations thereof. In embodiments, the substrate is a paper substrate. The paper substrate may be, for example, printer paper, notebook paper, photographic paper, security paper, cardboard, paperboard (e.g. container board or carton board), filter paper, envelopes, newspaper, gift wrap, or another in type of paper. In other embodiments, the substrate is a polymeric substrate comprising a polymeric material. If the polymeric substrate contains the polymeric material in an amount of less than 100%, then the polymeric substrate may additionally contain a material chosen from natural fibers, non-polymeric synthetic fibers, metal, combinations thereof, and optionally other conventional additives known to be included in polymer layers. The substrate may comprise only one type of polymeric material, or alternatively, the substrate may comprise more than one type of polymeric material. In embodiments, the substrate comprises a polymer selected from polyethylene terephthalate, polypropylene, polyethylene, polyvinyl chloride, polycarbonate, and combinations thereof.

In embodiments, when the substrate is a polymeric substrate, the polymeric substrate is pretreated. As used herein, a “pretreated polymeric substrate” refers to a substrate comprising a polymeric material that has been subjected to a surface treatment that physically and/or chemically modifies material at the substrate surface prior to application of any primer composition onto any surface of the substrate. Sufficient adhesion of an ink layer to a substrate may be particularly difficult with polymeric substrates. Pretreatment may contribute to improved adhesion by removing surface defects and modifying the surface energy of the substrate, but may not improve adhesion enough to reach a satisfactory level of adhesion. The polymeric substrate may already be pretreated when it is obtained, or alternatively, a step of pretreating the polymeric substrate may be incorporated into the methods provided herein. In embodiments, the polymeric substrate is pretreated by a method selected from plasma treatment, ultraviolet/ozone treatment, mechanical treatment, and combinations thereof. Examples of plasma treatments include corona treatment, plasma etching, and dielectric barrier discharge plasma treatment. Examples of mechanical treatments include sanding and brushing.

The substrate may be in the form of a sheet, a roll, or another form. In embodiments, the substrate is in a form such that the substrate is capable of being fed through a digital LEP printer. In embodiments, the substrate has a thickness of from about 20 μm to about 800 μm, alternatively from about 25 μm to about 600 μm, alternatively from about 50 μm to about 500 μm. In embodiments, the substrate has a surface free energy (i.e. surface tension) of from about 20 dynes/cm to about 60 dynes/cm, alternatively from about 30 dynes/cm to about 50 dynes/cm, as determined using ACCU Dyne Test™ Marker Pens by Diversified Enterprises.

The primer composition is applied to the surface of the substrate to form the primer layer to enhance the adhesion of the substrate to an ink layer that may be subsequently formed on the primer layer. The primer layer, as referred to herein, is the layer upon which the Electroink composition is directly deposited. The presence of the primer layer on the substrate maximizes adhesion of the ink layer to the substrate and minimizes removal of portions of the ink layer due to smudging, rubbing, or other forces. The enhanced adhesion is at least in part due to the inclusion of functional groups present in polymers in the primer composition that interact effectively with liquid toners and ink layers through hydrogen bonding or ionic forces, improving the ink receptivity of the substrate.

The primer composition may be applied to only one surface of the substrate, or alternatively, the primer composition may be applied to multiple surfaces of the substrate. For example, if the substrate is in the form of a sheet, the primer layer may be applied to only one side of the sheet, or alternatively, the primer composition may be applied to both sides of the sheet. The primer composition may be applied to the entire surface of the substrate, or alternatively, the primer composition may be applied to only a portion of the surface of the substrate. The primer composition may be applied directly to the surface of the substrate such that the resulting primer layer is in direct contact with the surface of the substrate. The primer composition may be applied to the surface of the substrate by any known method, for example but without limitation, by spray coating, foam coating, curtain coating, roller coating, transfer coating, printing, or combinations thereof. The primer composition may be applied to the surface of the substrate either in a printing press (“in-line”) or separate from a printing press (e.g. in a substrate converter).

The primer composition that is applied to the surface of the substrate comprises a first polymer and a second polymer. As used herein, ordinal number terminology (i.e. “first,” “second,” etc.) is solely for the purpose of differentiating between two or more items and, unless otherwise stated, is not meant to imply any sequence or order of importance to one item over another or any order of addition. The first polymer is included in the primer composition to enhance the adhesion of the substrate to a subsequently formed ink layer. The first polymer may also contribute to minimized tackiness, minimized discoloration, and maximized stability of the primer compositions and of the resulting primer layer. The first polymer is soluble in water at a temperature of about 25° C. The first polymer may also be soluble in organic solvents, including, without limitation, dimethylformamide, methyl ethyl ketone, and methylene chloride, at a temperature of about 25° C. As used herein, “soluble” means that at least 1 gram of the polymer dissolves in 100 grams of solvent.

The first polymer may be a homopolymer, or alternatively, the first polymer may be a copolymer. As used herein, “copolymer” refers to a polymer comprising at least two different repeating units. The first polymer comprises a repeating unit, wherein the repeating unit comprises a localized negatively charged dipole having a local dipole moment of greater than 2 debyes, and wherein the repeating unit comprises no localized positively charged dipole having a local dipole moment of greater than 0.8 debyes. As used herein, a “dipole moment” refers to a measurement of the separation of charges within a functional group, arising from differences in electronegativity of atoms bound together. The dipole moment of a specific functional group may be determined using computational methods such as the Hartree-Fock calculations or density functional theory (DFT) calculations, or using experimental methods such as vibrational spectroscopy or electron diffraction. Examples of functional groups that are known to have a localized negatively charged dipole having a local dipole moment of greater than 2 debyes include carbonyl groups and phosphate groups. Examples of functional groups that are known to have a localized positively charged dipole having a local dipole moment of greater than 0.8 debyes include hydroxyl groups and nitrile groups. The presence of the strong localized negatively charged dipole in the repeating unit of the first polymer contributes to the ability of the first polymer to interact with a subsequently applied liquid toner, leading to maximized adhesion of the ink layer to the surface of the substrate.

In embodiments, the repeating unit of the first polymer comprises a tertiary amide group. In embodiments, at least one of the carbon atoms bonded to the nitrogen atom of the tertiary amide group has two or three hydrogen atoms bonded thereto, and the carbonyl group of the tertiary amide group is bonded to a —CH, —CH₂, or —CH₃ group. In embodiments, the repeating unit of the first polymer is formed from a monomer selected from the group of vinylpyrrolidone, an oxazoline-containing monomer, N-vinyl piperidone, N-vinylcaprolactam, N,N-dimethyl acrylamide, and combinations thereof. In embodiments, the repeating unit of the first polymer is formed from an oxazoline-containing monomer selected from 2-ethyl-2-oxazoline, 2-methyl-2-oxazoline, and combinations thereof. In embodiments, the first polymer may further comprise additional repeating units not specifically described herein.

In embodiments, the first polymer has a number average molecular weight of from about 50,000 g/mol to about 2,000,000 g/mol, alternatively from about 100,000 g/mol to about 2,000,000 g/mol, alternatively from about 200,000 g/mol to about 2,000,000 g/mol, alternatively from about 500,000 g/mol to about 2,000,000 g/mol. The number average molecular weight may represent the average over a distribution of molecular weights, or alternatively, the number average molecular weight may represent the average of the molecular weights of mixtures of two or more approximately monomolecular weight fractions. In embodiments, the first polymer may be present in the primer composition in an amount of from about 0.5 wt % to about 8 wt %, alternatively from about 0.8 wt % to about 6.5 wt %, based on a total weight of the primer composition.

The second polymer is included in the primer composition to enhance the adhesion of the substrate to a subsequently formed ink layer. The second polymer may be a homopolymer, or alternatively, the second polymer may be a copolymer. The second polymer includes a repeating unit including a tertiary amine group. The second polymer is a branched polymer having a branch with a primary amine group that is pendant from the backbone of the polymer. In embodiments, when the second polymer is a homopolymer, the second polymer has a primary amine functionality from about 25 mole % to about 45 mole %, alternatively from about 30 mole % to about 40 mole %. As used herein, “primary amine functionality” refers to the moles of primary amine groups present in the polymer as a percentage based on the total molecular weight of the polymer. The mole percentage of primary amines may be estimated using ¹³C nuclear magnetic resonance (NMR) spectroscopy. For example, the polymer may be diluted with deuterated water in a ratio of the polymer to the deuterated water of 1:3. The NMR spectra may be obtained using a Bruker AVIII 500 MHz instrument equipped with a 10 mm BBO probe. The primary amine functionality may be calculated using the following equation:

$$\% Primary amine = ( \frac{Ip}{Ip + ( \frac{Is}{2} ) + ( \frac{It}{3} )} ) * 100$$

wherein Ip is the integration of carbons containing primary amine at 36-43 ppm, Is is the integration of carbons containing primary amine at 44.2-49.3 ppm, and It is the integration of carbons containing primary amine at 49.6-57.5 ppm.

In embodiments, when the second polymer is a copolymer, the second copolymer may include a repeating unit selected from an amine-containing repeating unit (that is different from the above-described repeating unit including the tertiary amine group), a unit derived from a carboxylic acid, or a combination thereof. In embodiments, the second polymer may further comprise additional repeating units and/or functional groups not specifically described herein.

In embodiments, the second polymer has a number average molecular weight of from about 20,000 g/mol to about 2,000,000 g/mol, alternatively from about 700,000 g/mol to about 2,000,000 g/mol, alternatively from about 1,000,000 g/mol to about 2,000,000 g/mol. Without being bound by any theory, it is thought that molecular weights on the lower end of the range may contribute to maximized adhesion because a lower molecular weight correlates to a higher percentage of primary amine groups in the second polymer. However, it is thought that molecular weights at the higher end of the range may contribute to minimized discoloration. The second polymer may be present in the primer composition in an amount of from about 0.5 wt % to about 8 wt %, alternatively from about 0.8 wt % to about 6.5 wt %, based on a total weight of the primer composition.

The combination of the first polymer and the second polymer in the primer composition has been found to exhibit synergistic effects. For example, intermolecular interactions between functional groups in the first polymer and those in the second polymer may facilitate the observed enhanced drying by reducing the number of water molecules bound to the polymer chains. One would expect that unbound water molecules would possess a higher degree of mobility compared to those bound to polymeric chains, enhancing their drying rate and, consequently, that of the polymer mixture. A primer composition containing the first polymer alone does not effectively enhance adhesion of the ink layer to the substrate and ink affinity as compared to the surface of the substrate. A primer composition containing the second polymer alone effectively enhances the adhesion of the ink layer to the substrate and the ink affinity, but the second polymer alone may exhibit discoloration under certain conditions and may cause the primer layer to have a longer drying time than desired. It has been found that a primer layer formed from a primer composition containing the combination of the first polymer and the second polymer effectively enhances the adhesion of the ink layer to the substrate without exhibiting discoloration, while allowing shorter drying times than a primer composition containing the first polymer alone. In embodiments, a primer layer formed from the primer composition described herein exhibits less discoloration than a primer composition not in accordance with this disclosure having the same thickness, upon aging for a standard time period under the same conditions.

The primer composition containing both the first polymer and the second polymer may also exhibit rheological properties (e.g. viscosity) that are desirable for effective application and shelf stability. In embodiments, the primer composition described herein remains in usable condition for a longer period than a primer composition not in accordance with this disclosure having the same solids content and stored under the same conditions. The primer composition may be easier to clean off of equipment than a primer composition that does not contain both the first polymer and the second polymer (i.e. cleaning requires less time and less aggressive solvents). The primer layer formed from the coating composition containing both the first polymer and the second polymer may also have minimized tackiness upon drying, reducing the risk of the primed substrate sticking to another substrate during subsequent process steps (i.e. “blocking”).

In embodiments, the first polymer and the second polymer are present in the primer composition in a combined amount of from about 1 wt % to about 10 wt %, alternatively from about 2 wt % to about 8 wt %, alternatively from about 4 wt % to about 8 wt %, based on a total weight of the primer composition. In embodiments, the first polymer and the second polymer are present in the primer composition in a weight ratio of the first polymer to the second polymer of from about 19:1 to about 1:9, alternatively from about 9:1 to about 1:9, alternatively from about 9:1 to about 1:5, alternatively from about 1:5 to about 5:1, alternatively from about 1:4 to about 4:1. It has been found that when the weight ratio of the first polymer to the second polymer is within the recited ranges, the adhesion of the primer layer is maximized while causing minimal discoloration, and the drying time is minimized.

The excellent adhesion and drying time described herein can be achieved without requiring the inclusion of a binder in the primer composition. In embodiments, the primer composition contains less than 30 wt %, alternatively less than 10 wt % of a binder, based on a total weight of the primer composition. The primer composition may be substantially free of a binder. As used herein, a “binder” refers to a film-forming component that is different from the first polymer and the second polymer. For example, a binder may be a starch, a protein, or a latex polymer. A binder may be an acrylic polymer, an epoxy resin, a polyurethane, or an alkyd resin. In embodiments, the primer composition contains less than 30 wt %, alternatively less than 10 wt % of any additional polymer different from the first polymer and the second polymer. The primer layer may be substantially free of any additional polymer different from the first polymer and the second polymer.

The primer composition further comprises a solvent. The primer composition may include only one solvent, or alternatively, the primer composition may include more than one solvent. In embodiments, the solvent is water. If both water and a non-aqueous solvent are present in the primer composition, the water may be present in amount of from about 92 wt % to 99 wt %, alternatively from about 95 wt % to about 99 wt %, alternatively from about 98 wt % to 99 wt %, based on a total weight of all solvents present in the primer composition. The solvent may be present in the primer composition in an amount of from about 50 wt % to about 99 wt %, based on a total weight of the primer composition.

The primer composition may further comprise an additive. As used herein, the term “additive” does not encompass the first polymer and the second polymer as described herein. In embodiments, the additive is chosen from surface tension modifiers, rheology modifiers, pH adjusting agents, UV absorbers, stabilizers, fillers, biocides, defoamers, waxes, pigments, dyes, crosslinkers, or combinations thereof. In embodiments, the primer composition includes an additional polymer different from the first polymer and the second polymer.

In embodiments, solids content of the primer composition is from about 2 wt % to about 12 wt %, alternatively from about 5 wt % to about 10 wt %, based on a total weight of the primer composition. In embodiments, the primer composition has a dynamic viscosity of from about 10 cP to about 100 cP, alternatively from about 15 cP to about 60 cP, as measured with total solids of 8% using a Brookfield viscometer at 60 rpm using an LV spindle number 1 at 25° C. When the viscosity of the primer composition is within the recited ranges, the primer composition can be effectively applied to the substrate using a variety of methods, and the resulting primer layer may have a more uniform thickness and distribution than a primer layer formed from a primer composition having a viscosity outside of the recited range.

In embodiments, the primer composition is applied to the substrate in an amount of from about 0.1 g/m² to about 0.4 g/m², alternatively from about 0.3 g/m² to about 0.6 g/m², expressed as a total dry weight of the primer composition applied based on a total surface area of the substrate. In embodiments, the resulting primer layer has a thickness of from about 0.1 μm to about 3 μm, alternatively from about 0.5 μm to about 2 μm, alternatively from about 0.5 μm to about 1.5 μm. The thickness of the primer layer may depend on the solids content of the primer composition, the method used to apply the coating composition to the surface of the substrate, and the viscosity of the primer composition.

In embodiments, the methods provided herein further comprise a step of drying the primer layer, in accordance with standard practice. The drying step removes at least some of the solvent present in the primer layer. The primer layer may be dried after the primer composition is applied to the surface of the substrate to form the primer layer and before any subsequent layers are applied on top of the primer layer. The primer layer may be dried in-line in a printing press, or alternatively, the primer layer may be dried separately from a printing press. The primer layer may be dried through any method known by a person of skill in the art. In embodiments, the primer layer is dried by infrared drying, hot-air drying, or a combination thereof. In embodiments, the primer layer is dried in an environment having a temperature of from about 50° C. to about 120° C., alternatively from about 60° C. to about 90° C. The recited drying temperatures may represent lower temperatures than typically required to dry primer layers. Lower drying temperatures may lead to minimized distortion of the substrate and may allow for the use of substrates that are more sensitive to extreme temperatures. In embodiments, the primer layer contains less than or equal to 10 wt % water, alternatively less than or equal to 1 wt % water, based on a total weight of the primer layer, after the drying step.

In embodiments, the primer layer requires a drying time of from about 2 seconds to about 20 seconds, alternatively from about 5 seconds to about 15 seconds. As used herein, the “drying time” refers to the amount of time from the start of the drying process until the primer layer contains less than or equal to 10 wt % water, alternatively less than or equal to 1 wt % water, based on a total weight of the primer layer. The primer layer may require a shorter drying time than is required to dry a primer layer containing the first polymer but not the second polymer or a primer layer containing the second polymer but not the first polymer, under the same drying conditions. In embodiments, the drying process for the primer layer described herein may require from about 2% to about 10% less time, based on a total time required to dry the primer layer, as compared to a primer layer not in accordance with this disclosure. A minimized drying time may allow faster running of the printing process and thus higher efficiency and throughput, and the ability to increase the thickness of the coating for certain applications.

In embodiments, the resulting primer layer has a thickness of from about 0.1 μm to about 2 μm, alternatively from about 0.5 μm to about 1.5 μm, after the primer layer is dried.

In embodiments, the methods provided herein further comprise a step of applying a liquid toner to the primer layer to form an ink layer. The ink layer may be formed within one year, alternatively within one month, alternatively within one week, alternatively within one day, alternatively within one hour, alternatively within 30 minutes, alternatively within 15 minutes, alternatively within 5 minutes, alternatively immediately after the primer layer is formed and dried. The liquid toner may be applied directly to the primer layer such that the resulting ink layer is in direct contact with the primer layer. The liquid toner may be applied to the primer layer by pressing, inkjet printing, or any other known method. In embodiments, the liquid toner is applied to the primer layer using liquid electrophotographic printing. As used herein, “liquid electrophotographic printing” refers to a printing process in which a liquid toner is applied to a substrate using a printing press such as an HP® Indigo™ digital printing press. As used herein, liquid electrophotographic printing does not refer to or encompass the offset printing process known in the field as lithography. In electrophotographic printing, toner ink layers are formed on a drum, transferred from the drum to a heated rubber blanket, and then transferred from the heated rubber blanket to the substrate.

The liquid toner may be 100% black toner, or alternatively, the liquid toner may be photo toner in a variety of colors. In embodiments, the liquid toner comprises about 52 parts yellow, 66 parts magenta, 72 parts cyan, and 100 parts black toner (“290 photo toner”). In embodiments, the liquid toner is a nonaqueous suspension of pigment particles having a D₅₀ average particle size of from about 1 μm to about 2 μm. The pigment particles may be suspended in a polymer and/or an oil.

The ink layer may cover only one surface of the substrate, or alternatively, the ink layer may cover multiple surfaces of the substrate. The ink layer may cover the entire surface of the substrate, or alternatively, the ink layer may cover only a portion of the surface of the substrate. In embodiments, the ink layer has an adhesion to the substrate after cooling to a temperature of about 25° C. and aging for one hour of from about 80% to about 100%, alternatively from about 85% to about 100%, alternatively from about 90% to about 100%, alternatively from about 95% to about 100%, as measured by determining the percentage of the originally formed ink layer remaining on the substrate after applying Scotch® 610 tape (polymeric substrates) or Masking Tape 234 (paper substrates), commercially available from 3M Company, on top of the ink layer, fixing the tape using a 1 kg (paper substrates) or 2 kg (polymeric substrates) roller, and peeling the tape off at an angle of 180° at a constant rate.

### EXAMPLES

### Examples 1-2

Six sheets of biaxially oriented polyethylene terephthalate (BOPET) having a thickness of about 180 μm were corona treated with a corona power of 1.3 kW and a feeding rate of 5 sheets per minute resulting in a surface free energy of 44 dynes/cm determined using ACCU Dyne Test™ Marker Pens by Diversified Enterprises. An aqueous primer composition was formed having a solids content of about 8% by weight. The primer composition contained branched polyethyleneimine (PEI) with weight average molecular weight of about 750,000 Daltons and poly-2-ethyl-2-oxazoline (PEtOx) with weight average molecular weight of about 500,000 Daltons. The weight ratio of PEI to PEtOx in the primer composition was about 1:1. The primer composition was applied to the corona treated BOPET sheets via roll-to-roll transfer using a Digicut A3+ Coating Machine to form a primer layer having a thickness of approximately 1 μm.

### Comparative Examples 1-6

Comparative Examples 1-6 are comparative examples not in accordance with this disclosure. Sheets of biaxially-oriented polyethylene terephthalate (BOPET) having a thickness of about 180 μm were corona treated with a corona power of 1.3 kW and a feeding rate of 5 sheets per minute. Then, for Comparative Examples 1-2, no primer composition was applied to the corona treated BOPET sheets. For Comparative Examples 3-4, an aqueous primer composition containing PEtOx having a molecular weight of about 500,000 g/mol at 8% solids by weight was applied to the corona treated BOPET sheets using the method described above for Examples 1-2. For Comparative Examples 5-6, an aqueous primer composition containing PEI and commercially available from Michelman, Inc. under the trade name DigiPrime® 050 was applied to the corona treated BOPET sheets using the method described above for Examples 1-2.

For Examples 1-2 and Comparative Examples 3-6, the primer layer was dried via convection using a conveyor drying at 80° C. for 15 seconds at a rate of 5 sheets/minute. For Examples 1-2 and Comparative Examples 1-6, an ink layer was formed on top of the primer layer, or on top of the substrate if no primer layer was present. To form the ink layer, rectangle ink layers were printed onto the substrate using an HP® Indigo™ 7500 printer in 4 shot mode. For Example 1 and Comparative Examples 1, 3, and 5, the ink layer was formed from 100% black liquid toner, which comprises only black toner. For Example 2 and Comparative Examples 2, 4, and 6, the ink layer was formed from 290 photo toner, which comprises about 52 parts yellow, 66 parts magenta, 72 parts cyan, and 100 parts black toner.

Adhesion tests were performed by the Rochester Institute of Technology in compliance with the standard test procedures set forth by HP® for testing the adhesion of ink applied with one of their Indigo™ printing presses. The adhesion of the ink was tested by applying Scotch® 610 tape, commercially available from 3M Company, on top of the ink layer on each printed substrate. The tape was applied on the printed substrate 0 minutes (immediately), 10 minutes, and 60 minutes after the ink layer was printed onto the substrate. The tape was fixed using a 2 kg roller. The tape was peeled off at an angle of 180° over a period of one second. Then, the amount of ink remaining was electronically evaluated from digital images of the test pages obtained using a flatbed scanner. The percentage of ink adhesion was determined by dividing the amount of ink remaining by the amount of ink in the initially formed ink layer and multiplying by 100. The results are shown in Tables 1 and 2 below.

TABLE 1
Results of Adhesion Tests for Examples 1-2

| | | | | Percent Ink | Percent Ink | Percent Ink |
|---|---|---|---|---|---|---|
| | | | | Adhesion: | Adhesion: | Adhesion: |
| Example | Substrate | Primer | Ink | 0 Minutes | 10 Minutes | 60 Minutes |
| Example 1 | BOPET | PEtOx/PEI | 100% | 100% | 100% | 100% |
| | | | Black | | | |
| Example 2 | BOPET | PEtOx/PEI | 290 | 100% | 100% | 100% |
| | | | Photo | | | |

TABLE 2
Results of Adhesion Tests for Comparative Examples 1-6

| | | | | Percent Ink | Percent Ink | Percent Ink |
|---|---|---|---|---|---|---|
| | | | | Adhesion: | Adhesion: | Adhesion: |
| Example | Substrate | Primer | Ink | 0 Minutes | 10 Minutes | 60 Minutes |
| Comparative | BOPET | None | 100% | 1% | 1% | 1% |
| Example 1 | | | Black | | | |
| Comparative | BOPET | None | 290 | 0% | 0% | 1% |
| Example 2 | | | Photo | | | |
| Comparative | BOPET | PEtOx | 100% | 6% | 7% | 23% |
| Example 3 | | | Black | | | |
| Comparative | BOPET | PEtOx | 290 | 10% | 19% | 61% |
| Example 4 | | | Photo | | | |
| Comparative | BOPET | PEI | 100% | 100% | 100% | 100% |
| Example 5 | | (DigiPrime ®050) | Black | | | |
| Comparative | BOPET | PEI | 290 | 99% | 99% | 100% |
| Example 6 | | (DigiPrime ®050) | Photo | | | |

In order to have a “3-star rating,” an average of at least 90% of the black ink and at least 80% of the photo ink must remain after the peeling tests are performed. The results in Tables 1-2 show that only the PEI primer and the PEI/PEtOx primer would receive a “3-star rating.” The adhesion results show that a corona treated BOPET substrate performs very poorly in terms of ink adhesion when no primer composition is applied to the substrate (Comparative Examples 1-2). When a primer containing PEtOx (but not PEI) is applied to the substrate (Comparative Examples 3-4), the ink adhesion is slightly improved by the primer, but the adhesion is still poor and does not come close to a “3-star rating.” When a primer containing PEI (but not PEtOx) is applied to the corona treated BOPET substrate (Comparative Examples 5-6), the adhesion performance is excellent and gets a “3-star rating”. When a primer containing both PEI and PEtOx is applied to the substrate (Examples 1-2), the adhesion performance is still excellent and gets a “3-star rating.” This demonstrates that including PEtOx itself in a primer composition leads to insufficient adhesion, but including PEtOx in a primer composition with PEI does not negatively affect the adhesion performance achieved by PEI in the absence of PEtOx.

### Examples 3-6

For Examples 3-6, the procedure described above for Examples 1-2 was followed, except that the primer composition had a solids content of 6 wt %, and different substrates were used. For Examples 3-4, the substrates were corona treated sheets of polyvinyl chloride (PVC) having a thickness of about 300 μm and a surface free energy of 42 dynes/cm determined using ACCU Dyne Test™ Marker Pens by Diversified Enterprises. For Examples 5-6, the substrates were corona treated sheets of polycarbonate (PC) with a thickness of about 180 μm and a surface free energy of 42 dynes/cm determined using ACCU Dyne Test™ Marker Pens by Diversified Enterprises. Further, for Examples 5-6, the weight ratio of PEtOx to PEI in the primer composition was 3:1. For Examples 3 and 5, 100% black ink was used. For Examples 4 and 6, 290 photo ink was used. The ink adhesion was assessed using the peeling tests described above. The results are shown below in Table 3.

TABLE 3
Results of Adhesion Tests for Examples 3-6

| | | | | Percent Ink | Percent Ink | Percent Ink |
|---|---|---|---|---|---|---|
| | | | | Adhesion: | Adhesion: | Adhesion: |
| Example | Substrate | Primer | Ink | 0 Minutes | 10 Minutes | 60 Minutes |
| Example 3 | PVC | PEtOx/PEI | 100% | 100% | 100% | 100% |
| | | | Black | | | |
| Example 4 | PVC | PEtOx/PEI | 290 | 100% | 100% | 100% |
| | | | Photo | | | |
| Example 5 | PC | PEtOx/PEI | 100% | 99% | 100% | 100% |
| | | | Black | | | |
| Example 6 | PC | PEtOx/PEI | 290 | 98% | 97% | 100% |
| | | | Photo | | | |

The results of Examples 3-6 show that when a primer composition containing PEtOx and PEI is applied to a corona treated PVC substrate and a corona treated PC substrate, the ink adhesion results are similar to when a primer composition containing PEtOx and PEI is applied to a corona treated BOPET substrate. The ink adhesion performance is excellent and gets a “3-star rating.”

### Example 7

A round untreated BOPET film having a diameter of about 88 mm was placed in an aluminum sample pan. The substrate free energy was 36 dynes/cm determined using ACCU Dyne Test™ Marker Pens by Diversified Enterprises. The primer composition was similar to the primer composition described above for Examples 1-2, except that the solids content was 6 wt % and the second polymer was polyethyleneimine copolymer with a weight average molecular weight of 2,000,000 Daltons. About 1.5 grams of the PEtOx/PEI primer composition was coated on the BOPET film using a pipette.

### Example 7A

A round untreated BOPET film having a diameter of about 88 mm was placed in an aluminum sample pan. The substrate free energy was 36 dynes/cm determined using ACCU Dyne Test™ Marker Pens by Diversified Enterprises. The primer composition described above for Examples 1-2 was used. About 1.5 grams of the PEtOx/PEI primer composition was coated on the BOPET film using a pipette.

### Comparative Examples 7-9

Comparative Examples 7-9 are comparative examples not in accordance with this disclosure. The procedure described above for Example 7 was followed, except that different primer compositions were used. For Comparative Example 7, the primer composition contained PEtOx at 6 wt % solids. For Comparative Example 8, the primer composition contained a PEI copolymer having a weight average molecular weight of 2,000,000 Daltons at 6 wt % solids. For Comparative Example 9, the primer composition was a PEI primer composition commercially available from Michelman, Inc. under the trade name DigiPrime® 050.

### Comparative Examples 7A and 9A

Comparative Examples 7A and 9A are comparative examples not in accordance with this disclosure. The procedure described above for Example 7 was followed, except that different primer compositions were used. For Comparative Example 7A, the primer composition contained PEtOx at 8 wt % solids. For Comparative Example 9A, the primer composition was a PEI primer composition commercially available from Michelman, Inc. under the trade name DigiPrime® 050.

The primer layers in Comparative Examples 7-9, 7A, and 9A had thicknesses approximately equal to the thickness of the primer layers in Example 7 and Example 7A. It should be noted that the primer layers in Comparative Examples 7-9, 7A, and 9A and Examples 7 and 7A are thicker than the primer layers in the preceding examples because the method of applying the primer layer to the substrate is different (i.e. pipette application instead of commercial roll-to-roll application).

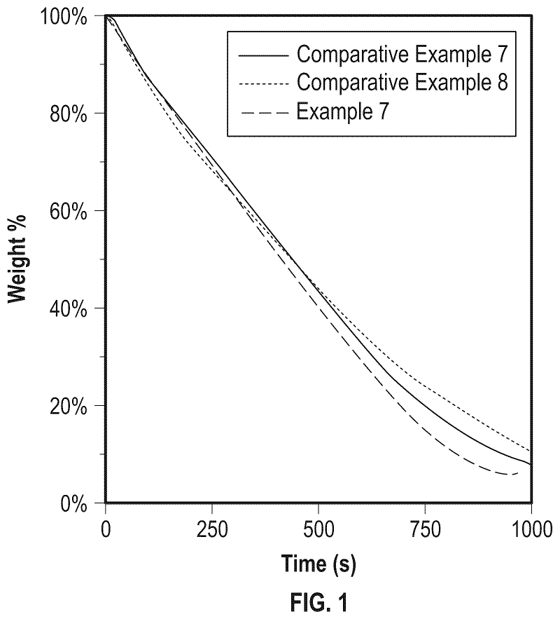

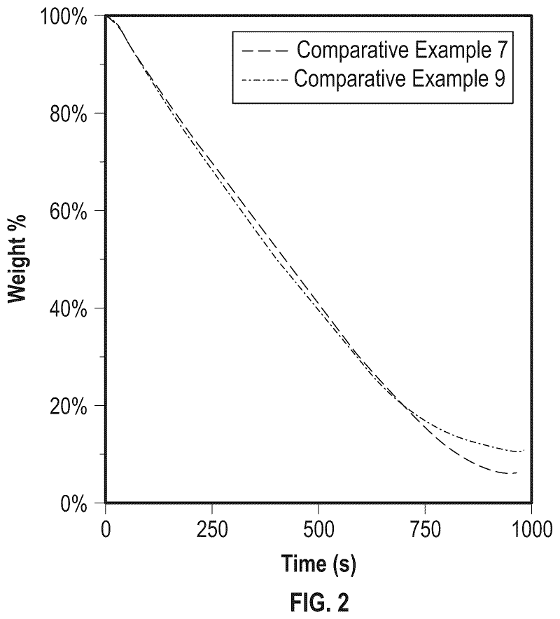

A Mettler Toledo HE73 Moisture Analyzer was used to detect the moisture content of each primer layer. The primer layer was dried in an environment having a temperature of 80° C. until no weight variation was detected by the moisture analyzer. Data was collected over a period of 1000 seconds. The sample weight percent values were calculated from the recorded masses at certain experimental times divided by the initial sample mass at an experimental time of about 0 seconds. The primer drying rates were evaluated based on the slopes of the weight % curves over the measured periods. The results are shown in FIGS. 1 and 2.

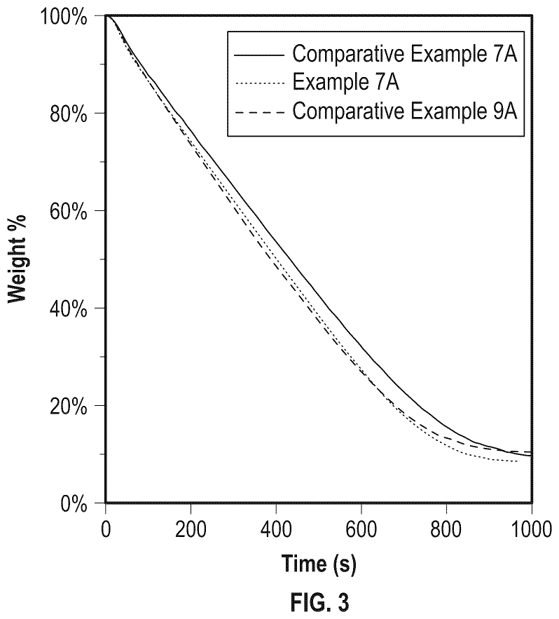

The results in FIGS. 1 and 3 show that the drying rate is faster for a primer composition containing a mix of both PEtOx and PEI than it is for a primer composition containing only PEtOx. The results in FIGS. 2 and 3 show that the drying rate of a primer composition containing both PEtOx and PEI is comparable to the conventionally used in-line primer, commercially available from Michelman, Inc. under the trade name DigiPrime® 050.

### Example 8

The primer composition described above for Examples 1-2 was used. The primer composition was coated onto an untreated BOPET film of 178 microns using a smooth (non-threaded) drawdown rod (Buschman, Co.) to form a primer layer. The primer layer was dried in an environment having a temperature of about 80° C. for 30 seconds. The resulting dried primer layer had a thickness of about 1 μm.

### Comparative Examples 10-11

Comparative Examples 10-11 are comparative examples not in accordance with this disclosure. The procedure described above for Example 8 was used, except that for Comparative Example 10, no primer was used, and for Comparative Example 11, a PEI primer commercially available from Michelman, Inc. under the trade name DigiPrime® 050 was used instead of the primer composition described above for Examples 1-2.

For Example 8 and Comparative Examples 10-11, the primed substrates were heated in an environment having a temperature of about 150° C. for 30 minutes, 60 minutes, 90 minutes, and 120 minutes. The discoloration of each primed substrate was measured using a Datacolor ELREPHO spectrophotometer. A white paper sheet was placed behind the primed BOPET substrates during the measurement to minimize the influence of film transparency on the measurement. The total color difference (ΔE*) was used as a quantitative indicator of darkening of the primer layer. The ΔE* values were obtained by comparing the spectrophotometry data of primed and heated samples with those for unprimed and non-heated substrates. The results are shown in Tables 4-5.

TABLE 4
Discoloration Results for Example 8

| | | | Color | Color | Color | Color |
|---|---|---|---|---|---|---|
| | | | Difference | Difference | Difference | Difference |
| | | | (ΔE*) | (ΔE*) | (ΔE*) | (ΔE*) |
| Example | Substrate | Primer | 30 Minutes | 60 Minutes | 90 Minutes | 120 Minutes |
| Example 8 | BOPET | PEtOx/PEI | 2.76 | 3.32 | 3.34 | 3.47 |

TABLE 5
Discoloration Results for Comparative Examples 10-11

| | | | Color | Color | Color | Color |
|---|---|---|---|---|---|---|
| | | | Difference | Difference | Difference | Difference |
| | | | (ΔE*) | (ΔE*) | (ΔE*) | (ΔE*) |
| Example | Substrate | Primer | 30 Minutes | 60 Minutes | 90 Minutes | 120 Minutes |
| Comparative | BOPET | None | 0.04 | 0.10 | 0.17 | 0.14 |
| Example 10 | | | | | | |
| Comparative | BOPET | PEI | 4.30 | 5.54 | 5.73 | 5.95 |
| Example 11 | | (DigiPrime ®050) | | | | |

The results in Tables 4 and 5 show that using a primer on a BOPET substrate leads to increased discoloration (higher ΔE*) when the substrate is heated over time. The samples primed with the PEtOx/PEI primer exhibited much lower ΔE* than the samples primed with the DigiPrime® 050 primer. Thus, the PEtOx/PEI primer leads to less discoloration of the sample over time.

### Examples 9-10

Untreated sheets of a commercially available folding carton board were used as received. An aqueous primer composition was formed having a solids content of about 6% by weight. The primer composition contained branched polyethyleneimine (PEI) with weight average molecular weight of about 750,000 Daltons and poly-2-ethyl-2-oxazoline (PEtOx) with weight average molecular weight of about 500,000 Daltons. The weight ratio of PEI to PEtOx in the primer composition was about 1:1. The primer composition was applied to the untreated folding carton board sheets via roll-to-roll transfer using a Digicut A3+ Coating Machine to form a primer layer having a thickness of approximately 1 μm.

### Comparative Examples 12-15

The procedure described above for Examples 9-10 was used, except for the following differences. For Comparative Examples 12-13, no primer composition was applied to the untreated folding carton board sheets. For Comparative Examples 14-15, an aqueous primer composition containing PEtOx having a molecular weight of about 500,000 Daltons at 4% solids by weight was applied to the untreated folding carton board sheets.

For each of Examples 9-10 and Comparative Examples 12-15, the primer layer was dried as described above for Examples 1-2 and Comparative Examples 3-6, and an ink layer was formed as also described above for Examples 1-2 and Comparative Examples 3-6. For Example 9 and Comparative Examples 12 and 14, the ink layer was formed from 100% black liquid toner. For Example 10 and Comparative Examples 13 and 15, the ink layer was formed from 290 photo toner.

Adhesion tests were performed as described above for Examples 1-2 and Comparative Examples 3-6, except that the tape applied to the ink was Masking Tape 234, commercially available from 3M Company, and the tape was fixed using a 1 kg roller. The results are shown below in Tables 6 and 7.

TABLE 6
Results of Adhesion Tests for Examples 9-10

| | | | | Percent Ink | Percent Ink | Percent Ink |
|---|---|---|---|---|---|---|
| | | | | Adhesion: | Adhesion: | Adhesion: |
| Example | Substrate | Primer | Ink | 0 Minutes | 10 Minutes | 60 Minutes |
| Example 9 | Folding | PEtOx/PEI | 100% | 100% | 100% | 100% |
| | Carton | | Black | | | |
| | Board | | | | | |
| Example 10 | Folding | PEtOx/PEI | 290 | 100% | 100% | 100% |
| | Carton | | Photo | | | |
| | Board | | | | | |

TABLE 7
Results of Adhesion Tests for Comparative Examples 12-15

| | | | | Percent Ink | Percent Ink | Percent Ink |
|---|---|---|---|---|---|---|
| | | | | Adhesion: | Adhesion: | Adhesion: |
| Example | Substrate | Primer | Ink | 0 Minutes | 10 Minutes | 60 Minutes |
| Comparative | Folding | None | 100% | 59% | 63% | 64% |
| Example 12 | Carton | | Black | | | |
| | Board | | | | | |
| Comparative | Folding | None | 290 | 30% | 39% | 43% |
| Example 13 | Carton | | Photo | | | |
| | Board | | | | | |
| Comparative | Folding | PEtOx | 100% | 73% | 80% | 81% |
| Example 14 | Carton | | Black | | | |
| | Board | | | | | |
| Comparative | Folding | PEtOx | 290 | 50% | 57% | 58% |
| Example 15 | Carton | | Photo | | | |
| | Board | | | | | |

The results in Tables 6 and 7 show that an ink layer applied directly onto a folding carton board sheet (Comparative Examples 12-13) exhibits adhesion values that are higher than those of an ink layer applied directly onto a polymeric substrate. However, the observed values are still insufficient to achieve even a “1-star rating,” as described above. An ink layer applied onto a primer layer containing PEtOx in the absence of PEI and disposed on a folding carton board sheet (Comparative Examples 14-15) exhibits slightly improved adhesion as compared to an ink layer applied directly to the folding carton board sheet, achieving a “2-star rating.” However, excellent results (a “3-star rating”) are only observed when the ink layer is applied onto a primer layer containing a combination of PEtOx and PEI disposed on the folding carton board sheet (Examples 9-10).

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment of the present disclosure. It being understood that various changes may be made in the function and arrangement of elements described in an exemplary embodiment without departing from the scope of the present disclosure as set forth in the appended claims.

What is claimed is:

1. A method of enhancing adhesion of an ink layer to a surface of a substrate, the method comprising the steps of:
applying a primer composition to the surface to form a primer layer disposed on the substrate, the primer composition comprising:
a first polymer comprising a repeating unit, wherein the repeating unit comprises a localized negatively charged dipole having a local dipole moment of greater than 2 debyes, and wherein the repeating unit comprises no localized positively charged dipole having a local dipole moment of greater than 0.8 debyes; and
a second polymer comprising a repeating unit comprising a tertiary amine group, wherein the second polymer is a branched polymer having a branch with a primary amine group that is pendant from the backbone of the polymer;
wherein the first polymer and the second polymer are present in the primer composition in a weight ratio of the first polymer to the second polymer of from about 19:1 to about 1:9.

2. The method of claim 1, wherein the repeating unit of the first polymer comprises a tertiary amide group.

3. The method of claim 1, wherein the repeating unit of the first polymer is formed from a monomer selected from the group of vinylpyrrolidone, an oxazoline-containing monomer, N-vinyl piperidone, N-vinylcaprolactam, N,N-dimethyl acrylamide, and combinations thereof.

4. The method of claim 1, wherein the first polymer has a number average molecular weight of from about 50,000 g/mol to about 2,000,000 g/mol.

5. The method of claim 1, wherein the second polymer has a primary amine functionality from about 25 mole % to about 45 mole % of primary amines based on a total molecular weight of the second polymer.

6. The method of claim 1, wherein the second polymer has a number average molecular weight of from about 20,000 g/mol to about 2,000,000 g/mol.

7. The method of claim 1, wherein the first polymer and the second polymer are present in the primer composition in a ratio of the first polymer to the second polymer of from about 9:1 to about 1:5.

8. The method of claim 1, wherein the first polymer and the second polymer are present in the primer composition in a combined amount of from about 0.1 wt % to about 10 wt %, based on a total weight of the primer composition.

9. The method of claim 1, wherein the solids content of the primer composition is from about 5 wt % to about 12 wt %, based on a total weight of the primer composition.

10. The method of claim 1, wherein the primer composition is substantially free of a binder.

11. The method of claim 1, further comprising drying the primer layer.

12. The method of claim 11, wherein the primer layer is dried by infrared drying, hot-air drying, or a combination thereof.

13. The method of claim 11, wherein the primer layer is dried in an environment having a temperature of from about 60° C. to about 90° C.

14. The method of claim 1, further comprising applying a liquid toner to the primer layer to form an ink layer.

15. The method of claim 14, wherein the liquid toner is applied to the primer layer using liquid electrophotographic printing.

16. The method of claim 1, wherein the substrate is a polymeric substrate.

17. The method of claim 16, wherein the polymeric substrate is pretreated by a method selected from plasma treatment, ultraviolet/ozone treatment, or combinations thereof.

18. The method of claim 1, wherein the primer composition has a dynamic viscosity of from about 10 cP to about 100 cP, as measured with total solids of 8%, using a Brookfield viscometer at 60 rpm using an LV spindle number 1 at 25° C.

19. A composite structure, comprising:
a substrate; and
a primer layer disposed on the substrate, formed from a primer composition comprising:
a first polymer comprising a repeating unit, wherein the repeating unit comprises a localized negatively charged dipole having a local dipole moment of greater than 2 debyes, and wherein the repeating unit comprises no localized positively charged dipole having a local dipole moment of greater than 0.8 debyes; and
a second polymer comprising a repeating unit comprising a tertiary amine group, wherein the second polymer is a branched polymer having a branch with a primary amine group that is pendant from the backbone of the polymer;
wherein the first polymer and the second polymer are present in the primer composition in a weight ratio of the first polymer to the second polymer of from about 19:1 to about 1:9.

20. The composite structure of claim 19, further comprising an ink layer formed from an Electroink, disposed on the primer layer.
